(19) United States
(12) Patent Application Publication
(10) Pub. No.: US 2014/0093747 A1
(43) Pub. Date: Apr. 3, 2014

(54) MAGNETIC RECORDING MEDIUM WITH ANTI-FERROMAGNETICALLY COUPLED MAGNETIC LAYERS

(71) Applicant: HGST NETHERLANDS B.V., Amsterdam (NL)

(72) Inventor: Ernesto E. Marinero, Saratoga, CA (US)

(73) Assignee: HGST NETHERLANDS B.V., Amsterdam (NL)

(21) Appl. No.: 13/629,900

(22) Filed: Sep. 28, 2012

(51) Int. Cl. G11B 5/673; G11B 5/84; G11B 5/66

(52) U.S. Cl. 428/828.1; 428/828; 427/131

(57) ABSTRACT

A magnetic recording medium includes a substrate and a plurality of anisotropic magnetic layers applied over the substrate. The medium further includes at least one anti-ferromagnetic coupling layer between two adjacent anisotropic magnetic layers of the plurality of anisotropic magnetic layers.

### FIELD

The subject matter of the present disclosure relates to magnetic recording media, and more particularly relates to magnetic recording media with multiple magnetic layers.

### BACKGROUND

For many years conventional magnetic storage devices have been used to store data and information. Magnetic storage devices generally include units (“bits”) of magnetic material that can be polarized into distinct magnetic states, such as a positive state and a negative state. Conventionally, each bit stores binary information (either a 1 or a 0) according to the magnetic polarization state of the bit. Accordingly, magnetic storage devices generally include a “read” element that passes over the magnetic material and perceives the magnetic polarization state of each bit and a “write” element that passes over the magnetic material and changes the magnetic polarization state of each bit, thereby recording individual units of binary information. The amount of information that can be stored on a magnetic storage device is directly proportional to the number of magnetic bits on the magnetic storage device.

Various types of magnetic storage devices are known in the art and each type may involve a different fabrication process. For example, conventional granular magnetic recording devices include disks with magnetic layer bits that have multiple magnetic grains on each bit. All of the bits of a granular magnetic recording disk are coplanar and the surface of the disk is substantially smooth and continuous. In order to increase the amount of information that can be stored on a granular magnetic disk, the size of the bits can be decreased while keeping the grain size the same. However, with smaller bits there are fewer grains on each bit, which decreases the signal-to-noise ratio (less signal, more noise). In order to maintain a higher signal-to-noise ratio, methods have been developed that decrease both the bit size and the grain size, thus keeping the number of grains on each bit constant. However, when the grains become too small, thermal fluctuations can cause the grains to spontaneously reverse polarity, thus resulting in a loss of stored information.

Bit-patterned media devices are another example of magnetic storage devices. In bit-patterned media, the bits are physically etched into a surface using conventional lithographic etching techniques. In contrast to continuous or granular magnetic recording devices, bit-patterned media devices are topographically patterned with intersecting trenches and elevated bit islands. In some instances, the trenches are etched directly into a magnetic material, and in other instances the physical patterns are etched into a substrate and a magnetic material is coated over the patterned substrate. Because of the physical separation between the elevated magnetic bit islands and the depressed trenches, the width of each distinct magnetic bit island can be decreased in order to increase the areal bit density of the device while still maintaining a high signal-to-noise ratio and high thermal stability.

However, bit-patterned media devices are still limited by conventional patterning and fabrication processes. For example, bit-patterned magnetic recording media may be thermally and magnetically stable at bit densities of greater than 1 trillion bits per square inch (Tbit/in²). However, conventional lithography can only generate bit pattern densities up to about 0.5 Tbit/in². Although current density multiplication fabrication techniques (i.e. self-assembled structures and nano-formation building blocks) may facilitate a decrease in feature size and an increase in feature density, as bits get smaller, the magnetic stability and the signal-to-noise ratio of these bits will still decrease, effectively limiting the areal information density of conventional magnetic recording media.

### SUMMARY

From the foregoing discussion, it should be apparent that a need exists for increasing areal information density without necessarily increasing physical areal bit density. The subject matter of the present application has been developed in response to the present state of the art, and in particular, in response to the problems and needs in the art that have not yet been fully solved by currently available magnetic recording media devices and nano-fabrication methods. Accordingly, the present disclosure has been developed to provide a magnetic recording medium that includes multiple magnetic states within each bit for increasing areal information density.

According to one embodiment, a magnetic recording medium includes a substrate and a plurality of anisotropic magnetic layers applied over the substrate. The medium further includes at least one anti-ferromagnetic coupling layer between two adjacent anisotropic magnetic layers of the plurality of anisotropic magnetic layers.

In some implementations of the magnetic recording medium, each of the plurality of anisotropic magnetic layers is spaced apart from another of the anisotropic magnetic layers by an anti-ferromagnetic coupling layer. A ratio of the thickness of an anisotropic magnetic layer directly coating the substrate to an adjacent anti-ferromagnetic coupling layer can be in the range of between about 2:1 and 10:1. Each bit of the magnetic recording medium can be capable of achieving a number of magnetic states equal to at least 2ⁿ where the plurality of anisotropic magnetic layers has n number of layers.

According to certain implementations of the magnetic recording medium, the substrate includes bit-patterned features. In yet some implementations, the anisotropic magnetic layers and the anti-ferromagnetic coupling layer include bit-patterned features. At least one of the anisotropic magnetic layers can include a cobalt-platinum-chromium alloy. The anti-ferromagnetic coupling layer can include a ruthenium-cobalt alloy.

In some implementations of the magnetic recording medium, the substrate may include a conditioning layer. The conditioning layer can include an oxide-nucleation layer.

According to certain implementations of the magnetic recording medium, the at least one anti-ferromagnetic coupling layer includes a first anti-ferromagnetic coupling layer and a second anti-ferromagnetic coupling layer. The two anisotropic magnetic layers include a first anisotropic magnetic layer and a second anisotropic magnetic layer. The plurality of anisotropic magnetic layers also includes a third anisotropic magnetic layer. The second anisotropic magnetic layer is between the first and third anisotropic magnetic layers, the first anti-ferromagnetic coupling layer is positioned between the first and second anisotropic magnetic layers, and the second anti-ferromagnetic coupling layer is positioned between the second and third anisotropic magnetic layers.

According to another embodiment, a bit-patterned magnetic recording medium includes a substrate, a conditioning layer, a first anisotropic magnetic layer applied over the conditioning layer, an anti-ferromagnetic coupling layer applied over the first anisotropic magnetic layer, and a second anisotropic magnetic layer applied over the anti-ferromagnetic coupling layer. The conditioning layer can include an oxide-nucleation layer. The anti-ferromagnetic coupling layer can include a ruthenium-cobalt alloy. The first anisotropic magnetic layer can include a first cobalt-platinum-chromium alloy and the second anisotropic magnetic layer can include a second cobalt-platinum-chromium alloy. The first cobalt-platinum-chromium alloy can be CoCr₇Pt₂₅ and the second cobalt-platinum-chromium alloy can be CoCr₁₈Pt₁₂.

According to certain implementations of the bit-patterned magnetic recording medium, the thickness ratio of the first anisotropic magnetic layer to the anti-ferromagnetic coupling layer is between about 2:1 and 10:1. In some implementations, the thickness ratio of the first anisotropic magnetic layer to the anti-ferromagnetic coupling layer is between about 5:1 and 7:1. In yet one implementation, the thickness ratio of the first anisotropic magnetic layer to the anti-ferromagnetic coupling layer is about 6:1.

In some implementations of the bit-patterned magnetic recording medium, the thickness ratio of the first anisotropic magnetic layer to the second anisotropic magnetic layer is between about 3:2 and 10:1. In yet certain implementations, the thickness ratio of the first anisotropic magnetic layer to the second anisotropic magnetic layer is between about 5:2 and 8:1. According to one implementation, the thickness ratio of the first anisotropic magnetic layer to the second anisotropic magnetic layer is about 4:1.

The substrate of the bit-patterned magnetic recording medium can include self-assembled block copolymer patterns. Further, the bit-patterned magnetic recording medium can be a hard disk of a magnetic recording device.

According to yet another embodiment, a method for fabricating an anti-ferromagnetic recording medium includes providing a substrate, applying a conditioning layer over the substrate, applying a first anisotropic magnetic layer over the conditioning layer, applying an anti-ferromagnetic coupling layer over the first anisotropic magnetic layer, and applying a second anisotropic magnetic layer over the anti-ferromagnetic coupling layer.

Reference throughout this specification to features, advantages, or similar language does not imply that all of the features and advantages that may be realized with the present disclosure should be or are in any single embodiment of the invention. Rather, language referring to the features and advantages is understood to mean that a specific feature, advantage, or characteristic described in connection with an embodiment is included in at least one embodiment of the subject matter disclosed herein. Thus, discussion of the features and advantages, and similar language, throughout this specification may, but do not necessarily, refer to the same embodiment.

Furthermore, the described features, advantages, and characteristics of the disclosure may be combined in any suitable manner in one or more embodiments. One skilled in the relevant art will recognize that the subject matter of the present application may be practiced without one or more of the specific features or advantages of a particular embodiment. In other instances, additional features and advantages may be recognized in certain embodiments that may not be present in all embodiments of the disclosure.

These features and advantages of the present disclosure will become more fully apparent from the following description and appended claims, or may be learned by the practice of the disclosure as set forth hereinafter.

### BRIEF DESCRIPTION OF THE DRAWINGS

In order that the advantages of the disclosure will be readily understood, a more particular description of the disclosure briefly described above will be rendered by reference to specific embodiments that are illustrated in the appended drawings. Understanding that these drawings depict only typical embodiments of the disclosure and are not therefore to be considered to be limiting of its scope, the subject matter of the present application will be described and explained with additional specificity and detail through the use of the accompanying drawings, in which:

FIG. 1A is a top perspective view of one embodiment of a magnetic recording medium with a magnified view of magnetic bits across a substrate;

FIG. 1B is a top perspective view of one embodiment of a magnetic recording medium with a magnified view of bit-patterned magnetic bits across a substrate;

FIG. 2A is a cross-sectional side view of one embodiment of a bit-patterned magnetic recording medium;

FIG. 2B is a cross-sectional side view of another embodiment of a bit-patterned magnetic recording medium;

FIG. 3A is a cross-sectional side view of one embodiment of a magnetic recording medium that includes two magnetic layers;

FIG. 3B is a cross-sectional side view of another embodiment of a magnetic recording medium that includes two magnetic layers that are magnetically coupled across an intermediate layer;

FIG. 3C shows hysteresis loops for a magnetic recording medium that includes two magnetic layers that either have no intermediate layer between the magnetic layers or that are magnetically coupled across an intermediate layer;

FIG. 4A is a cross-sectional side view of one embodiment of a magnetic recording medium that includes two magnetic layers that are magnetically decoupled across an intermediate layer;

FIG. 4B shows hysteresis loops for a magnetic recording medium that includes two magnetic layers that are magnetically decoupled across an intermediate layer;

FIG. 5A is a cross-sectional side view of one embodiment of a magnetic recording medium that includes two magnetic layers that are anti-ferromagnetically coupled across an intermediate layer;

FIG. 5B shows hysteresis loops for a magnetic recording medium that includes two magnetic layers that are anti-ferromagnetically coupled across an intermediate layer; and

FIG. 6 is a schematic flow chart diagram of one embodiment of a method for fabricating a multi-layer magnetic recording medium.

### DETAILED DESCRIPTION

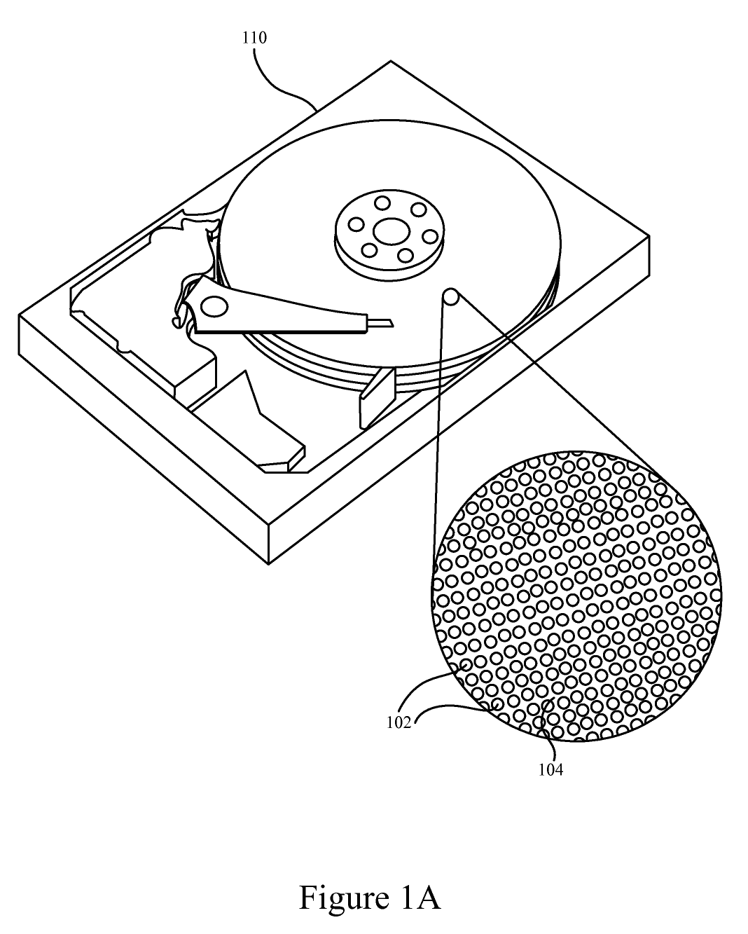

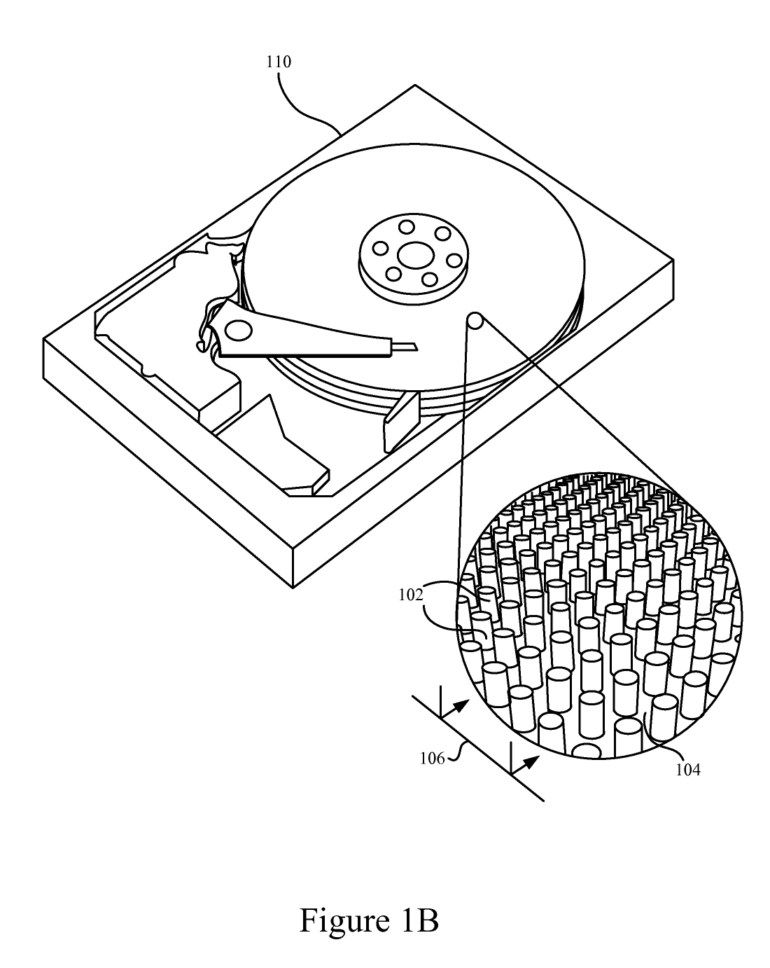

FIGS. 1A and 1B are perspective views of different embodiments of a magnetic recording medium with magnified views of magnetic bits 102 across a substrate 104. Although the depicted embodiments are hard disk drives 110, the subject matter of the present disclosure relates generally to any type of magnetic recording media. Throughout the disclosure, the term “magnetic recording medium” will refer to any apparatus or device that involves the magnetic storage of information. For example, in one embodiment “magnetic recording medium” may refer to a continuous/granular magnetic recording medium (such as depicted in FIG. 1A). In another embodiment, “magnetic recording medium” may refer to a bit-patterned magnetic recording medium (such as depicted in FIG. 1B). Thus, regardless of whether the magnetic bits 102 are coplanar with the substrate 104 or whether the magnetic bits 102 are topographically patterned into or on top of a substrate 104, the subject matter of the present disclosure applies generally to any apparatus or device that involves the magnetic storage of information.

As depicted in FIG. 1B, patterned media generally includes a substrate 104 with bits 102 etched into a surface of the substrate 104. The physically patterned substrate 104 may then be coated with a magnetic layer(s). The substrate 104 is generally a silicon wafer or other similar material, such as glass, aluminum alloy, nickel alloy, silicon alloy, and the like. In one embodiment, an inert filler material (not depicted) may be added between the bits 102 of the substrate 104 (in the trenches) in order to create a substantially smooth surface so that the tops of the bits 102 are coplanar with the surface of the filler material. In another embodiment the bit-patterned medium includes a substantially flat/continuous substrate upon which the magnetic layers are applied before etching so that the pattern of trenches and/or islands is formed directly into the magnetic material itself.

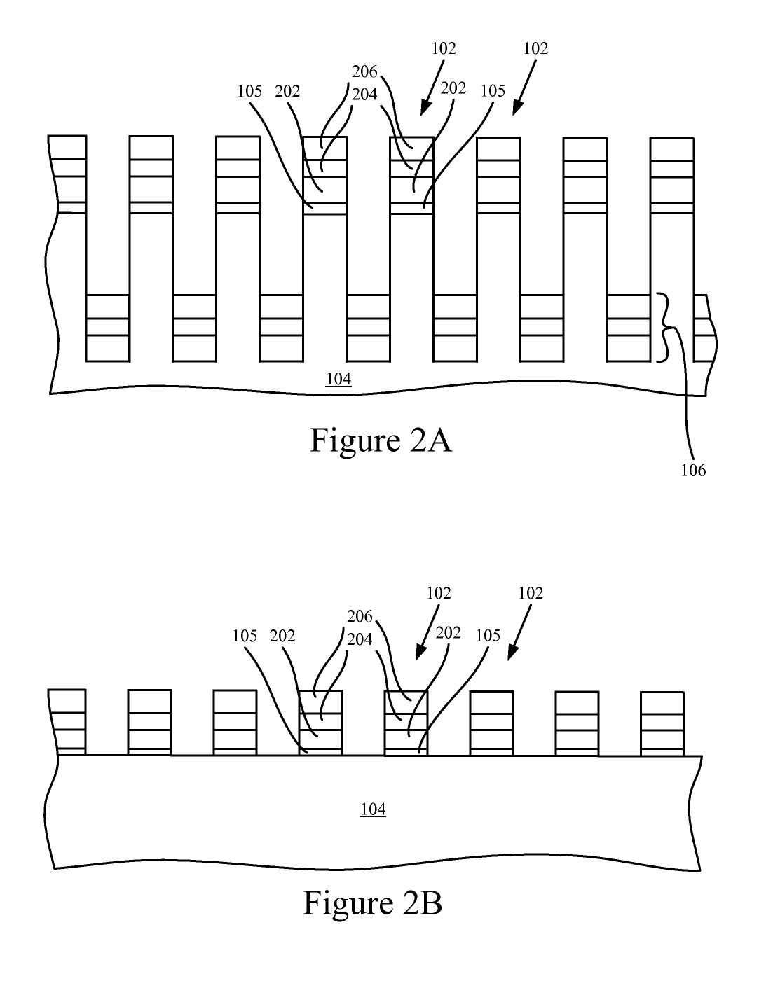

The bits 102 can range in width, height, size, and density, according to the specifics of a given application. For example, the bits 102 may be substantially cylindrical, as depicted, or the bits may be substantially rectangular, conical, elliptical, or pyramid-like. In lithographic patterning, the distance between features 102, known as the bit pitch, can be as small as 5-10 nanometers in some implementations. Density multiplication techniques, such as self assembly of block copolymers, may be used to decrease the bit pitch and therefore increase the areal bit density. Also included in FIG. 1B is a viewpoint 106 depicting a view along the surface of the substrate 104. This viewpoint 106 represents the perspective from which FIGS. 2A, 2B, 3A, 3B, 4A, and 5A are depicted.

FIGS. 2A and 2B are cross-sectional side views of embodiments of a bit-patterned magnetic recording medium. FIG. 2A depicts a bit-patterned substrate 104 that has been coated with a conditioning layer 105 and two magnetic layers 202, 206 that are separated from each other by an intermediate layer 204. As depicted, the portions of the magnetic material that coat the elevated islands constitute the layer that magnetically stores information. The portions of the magnetic material that coat the trenches 106, according to one embodiment, are magnetically poisoned and essentially function as non-magnet regions that distinguish the magnetic domains on each bit.

In one embodiment, the conditioning layer 105 is a component of the substrate 104. In another embodiment, the conditioning layer 105 is a substantially separate component. The conditioning layer 105 may be a single material or the conditioning layer 105 may include multiple materials and components that prepare and condition the surface of the substrate for subsequent processing and coating steps, such as additional conditioning materials, magnetic layers, and the like.

In one embodiment, the conditioning layer 105 includes at least one layer specifically configured to influence the magnetic anisotropy of a subsequently applied magnetic layer(s). For example, a nano-scale nucleation layer, such as tantalum oxide (“Ta₂O₅”), may constitute at least a portion of the conditioning layer 105. Ta₂O₅ reduces the intrinsic switching field of certain magnetic layers, such as cobalt-platinum-chromium alloy layers. The conditioning layer 105 may also include magnetic metals, magnetic alloys (not used for recording information), non-magnetic metal alloys, and the like. For example, alloys of nickel and refractory metals, such as tungsten and tantalum, may constitute a portion of the conditioning layer 105. Such alloys are well-suited for controlling the crystallographic properties and the magnetic axis orientation of subsequent magnetic recording layers.

In another embodiment, the conditioning layer 105 includes masking materials for controlling the fabrication of the magnetic recording medium. For example, silicon dioxide may be selected as a masking material in the conditioning layer and may be applied on the substrate 104 base. After the silicon oxide is applied, a layer of chromium may also be applied over the silicon oxide to form a double masking layer. Silicon dioxide and chromium are examples of “hard” masking materials that are substantially durable and resist damage or destruction when the magnetic recording medium is treated with reactive gases or chemical solvents during subsequent processing steps. These “hard” masking materials are generally used to protect the substrate while the outer-layers undergo chemical washing and etching. Accordingly, the conditioning layers, made from “hard” masking materials, provide a fabrication process with greater control in patterning and processing the substrate 104 because the conditioning layers allow the fabricator to control when a certain etching or washing process will penetrate the conditioning layer and therefore when the actual etching of the substrate 104 will occur. It is also contemplated that the conditioning layer 105 may include “soft” masking materials, such as polymer films, resist layers, etc. These “soft” conditioning layers are more susceptible to washing and etching treatments and therefore may not provide the level of protection that “hard” exterior layers can provide.

The conditioning layer 105, in one embodiment, may be a brush polymer material. Brush polymers are generally polymer chains of a certain length that are capable of adhering to a surface. Often brush polymers include both a “head” portion and a “tail” portion, where the head portion is attached to the surface and the tail portion hangs free and interacts with other nearby components. For example, poly methyl methacrylate (“PMMA”) may be used as a conditioning layer 105.

In addition to brush polymers, MAT polymers or other polymer films may be used as components of the conditioning layer 105 to coat the surface of the substrate 104. MAT materials are cross-linked polymers that have chemical surface features that allow subsequent layers of block copolymers to self-assemble into periodic alternating patterns. The selection of a proper conditioning layer 105 may be related to the patterning and density multiplication techniques that are subsequently employed. For example, patterning with electron-beam lithography may require a certain type of lithographic resist material, which may or may not adhere to certain conditioning layers 105.

Throughout the pages of the present disclosure, the term “intermediate layer” will refer to any non-magnetic material that spaces apart the multiple magnetic layers. In some embodiments, different types of intermediate layers are used to space apart different magnetic layers. For example, in one embodiment where cobalt-chromium-platinum alloys are used as the magnetic layer materials, a ruthenium-cobalt alloy may be the intermediate layer that spaces apart the two magnetic layers. Depending on the thickness and composition of the magnetic materials and the thickness and composition of the intermediate layer(s), various magnetic coupling configurations may be created in a magnetic recording medium.

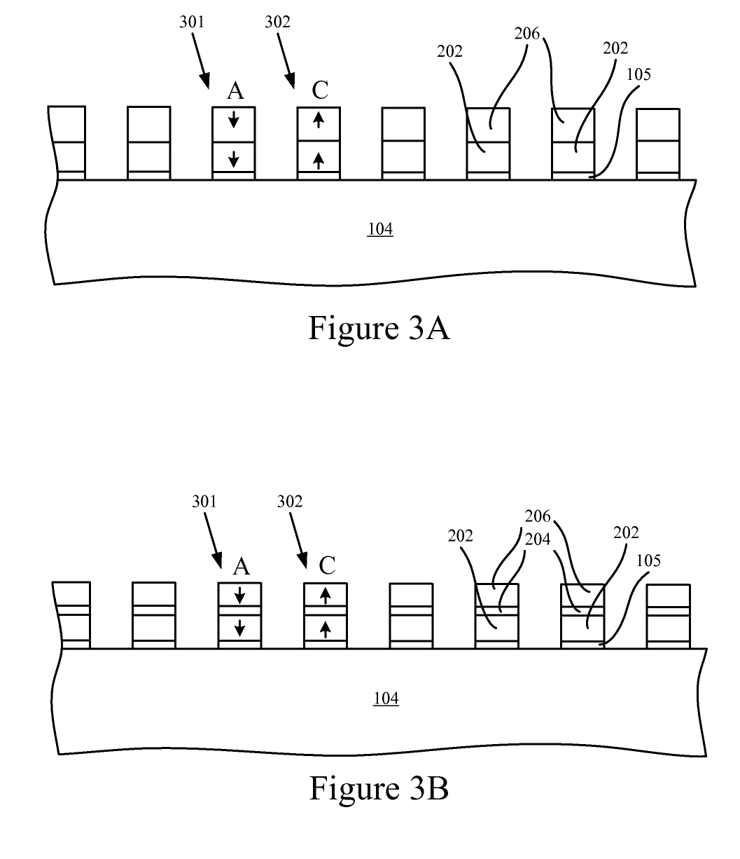

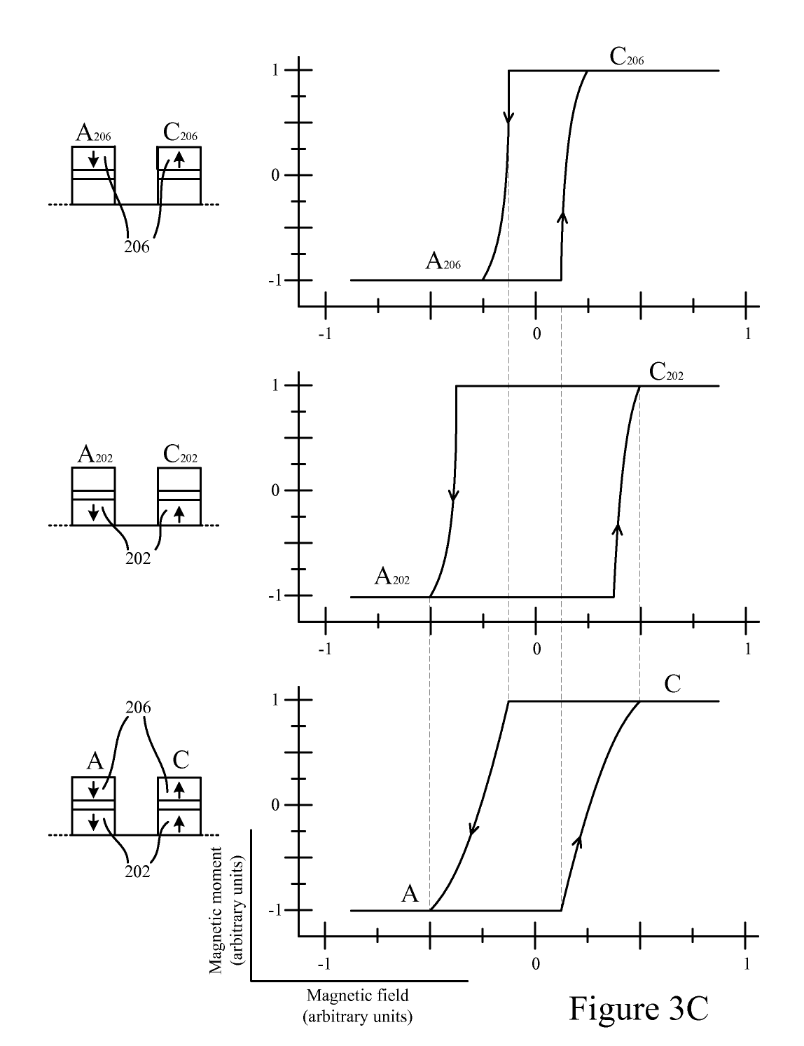

FIG. 2B depicts a substantially flat substrate 104 with a bit-patterned coating of a conditioning layer 105 and two magnetic layers 202, 206 that are separated by an intermediate layer 204. In order to describe the magnetic properties of a magnetic recording medium of the present disclosure, the following principles are described below as they pertain to magnetic recording media. First, details regarding magnetic materials and the alignment of magnetic dipoles within a magnetic layer are included below with reference to FIG. 2B. Second, details relating to the magnetic anisotropy of the aligned dipoles within a magnetic layer are included below, also with reference to FIG. 2B. Third, details relating to the polarization interactions between the multiple magnetic layers and the intermediate layer(s) are included below with reference to FIGS. 3A, 3B, 3C, 4A, 4B, 5A, and 5C. Also included below, with reference to FIGS. 3A, 3B, 3C, 4A, 4B, 5A, and 5C, is a description of the plurality of magnetic states that can be created using multiple magnetic layers. Thus, the remainder of the disclosure generally includes details relating to: (1) magnetic alignment of dipoles in a single magnetic layer, (2) the direction of the alignment of the dipoles in a single magnetic layer, and (3) the magnetic interactions between dipoles in separate magnetic layers.

First, FIG. 2B depicts a substrate 104 that is substantially flat and depicts bits 102 that have been physically patterned to form distinct magnetic island domains for recording information. Although the depicted embodiment includes two magnetic layers 202, 206 spaced apart by an intermediate layer 204, it is contemplated that more than two magnetic layers may comprise the magnetic recording medium of the present disclosure and that more than one intermediate layer may space apart the multiple magnetic layers. In one embodiment, each magnetic layer includes a single metallic component and in other embodiments each magnetic layer includes metallic alloys and/or multiple metallic components. Typical materials that comprise the magnetic layers generally include iron, cobalt, nickel, and alloys thereof. Ferromagnetic alloys also may include oxides, platinum group metals such (e.g. ruthenium, rhodium, palladium, and platinum), transition metals, and the like. The composition of the magnetic layers, whether consisting of a single component or a metallic alloy mixture, may be selected according to the specifics of a given application. In one embodiment, the two magnetic layers 202, 206 may include cobalt(Co)-chromium(Cr)-platinum(Pt) alloys. For example, the first magnetic layer 202 may be CoCr₇Pt₂₅ and the second magnetic layer 206 may be CoCr₁₂Pt₁₈.

Throughout the present disclosure, the term “magnetic layer” refers to any ferromagnetic material that has the characteristics of a permanent magnet; i.e. a material that, in pertinent part, exhibits a net magnetic moment in the absence of an external magnetic field—i.e. a magnetic remanence. It is noted that said remanence refers to the case when the thermal stability of the material is large enough to overcome the super paramagnetic limit of the material which depends on its magnetic anisotropy and sample volume.

Magnetism is the result of moving electric charge. For example, the spin of an electron in an atom or a molecule creates a magnetic dipole. A magnetic field is created when the magnetic dipoles in a material result in a net magnitude and direction. Thus, the magnetism of a material is directly related to the magnitude, direction, inter-alignment, and interaction of the magnetic dipoles in the material. For example, when an external magnetic field is applied over a piece of iron, adjacent dipoles generally align in the direction of the magnetic field and substantially remain aligned in the same direction even after the external field is removed, thus creating a net magnetic moment.

However, in context of the subject matter of the present disclosure, macro-scale alignment of the majority of dipoles in a magnetic material is not desired. Rather, the subject matter of the present disclosure relates to the magnetic polarization states of nano-regions of magnetic material. For example, in the embodiments of a bit-patterned magnetic recording medium as depicted in FIGS. 2A and 2B, the physically patterned distinct magnetic bits 102 form discrete magnetic domains. In one embodiment, these individual magnetic domains are especially important for promoting the alignment of the dipoles within the magnetic domain in order to create stable magnetic polarization states that may record information and data in a magnetic storage device.

Second, the magnetic layers 202, 206 may include anisotropic magnetic materials. Magnetic anisotropy is the directional dependence of a particular magnetic material. For example, an anisotropic magnetic layer 202, 206 may energetically favor certain alignments along certain axes. Anisotropic magnetic materials are well-suited for use in the present application because magnetic recording mediums generally include directionally specific magnetization formats (e.g. longitudinal or perpendicular). Thus, in one embodiment, the magnetic dipoles in a single magnetic domain 102 need not only be aligned, but must be aligned in a certain direction so as to ensure the proper reading and writing of information. There are several factors that affect the magnetic anisotropy of a material, including the magneto-crystallinity of a material, dipole-dipole interactions, exchange interactions, and general principles of electromagnetism.

In one embodiment, as described above with reference to FIG. 2A, the conditioning layer 105 may include materials that promote directional alignment of the magnetic layer dipoles. For example, a bilayer of a nickel-tungsten alloy together with Ru, in one embodiment, promotes the perpendicular (with respect to the surface of the substrate 104) alignment of the dipoles. Also, the intermediate layer(s) 204 may contribute to the magnetic anisotropy of the magnetic layers 202, 206, as will be discussed below, and may otherwise mediate the interaction between the multiple magnetic layers.

FIG. 3A is a cross-sectional side view of one embodiment of a magnetic recording medium that includes two magnetic layers 202, 206. In the depicted embodiment, a first anisotropic magnetic layer 202 is on a substrate 104, a second anisotropic magnetic layer 206 is on the first anisotropic magnetic layer 202 and there is no intermediate layer. Generally, growing the media directly on substrate 104, does not produce the crystallographic orientation and the out of plane magnetic alignment needed for the invention to function. Accordingly, conditioning layer 105 is needed. Specifically, two bits 301, 302 are depicted that represent the two magnetic configurations, A and C, of the dipoles of the two magnetic layers 202, 206. In one embodiment in a first bit 301, the first 202 and second 206 magnetic layers are directionally aligned with each other and both have a negative polarization (A). Throughout the disclosure, “downward” arrows, as depicted in the first bit 301 of FIG. 3A, refer to a negative polarization of the magnetic dipoles and “upward” arrows, as depicted in the second bit 302 of FIG. 3A, refer to a positive polarization of the magnetic dipoles.

Since there is no intermediate layer between the magnetic layers 202, 206 in FIG. 3A, the first anisotropic magnetic layer 202 and the second anisotropic magnetic layer 206 are magnetically coupled and therefore the dipoles in the two magnetic layers 202, 206 have the same polarization state and simultaneously switch polarization states when a specific external magnetic field is applied over the magnetic layers (see FIG. 3C). Thus, when coupled, the individual polarization states of the magnetic layers 202, 206 are either both positive (C) or both negative (A).

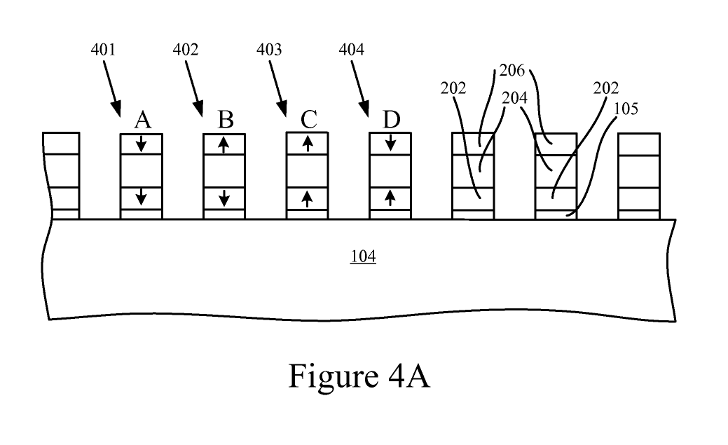

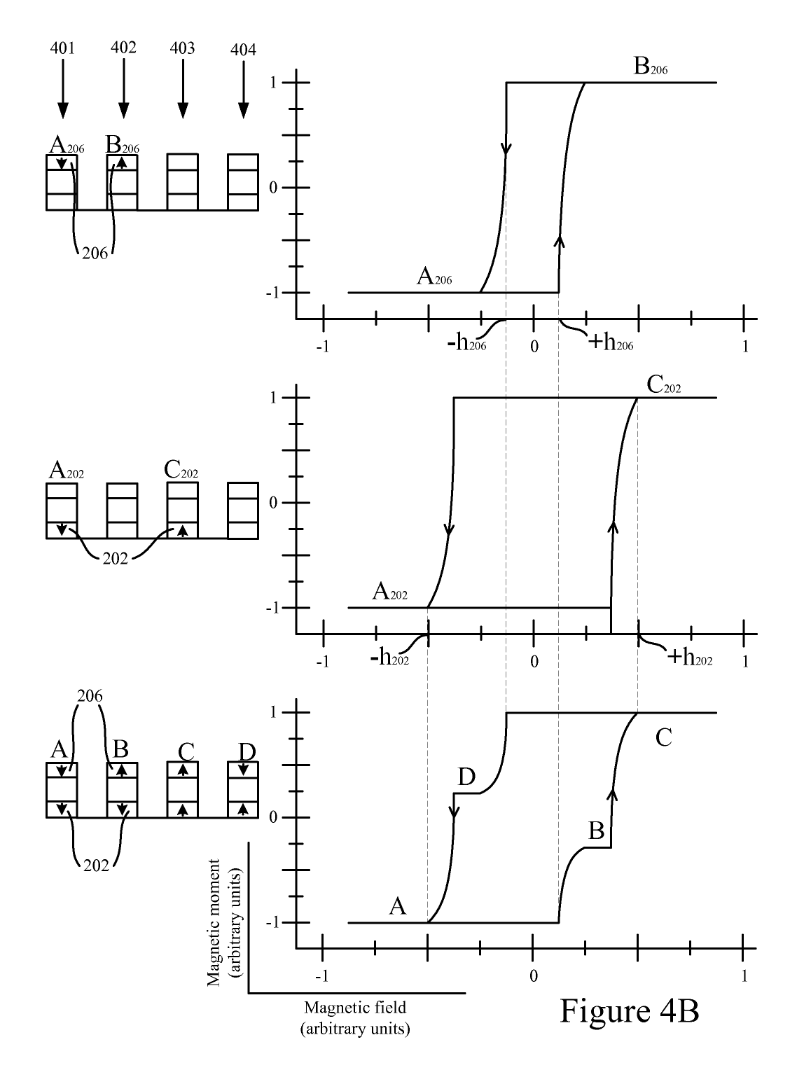

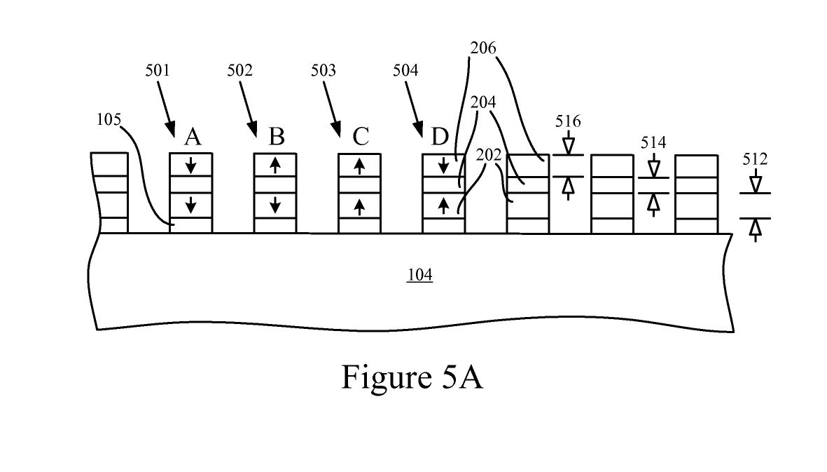

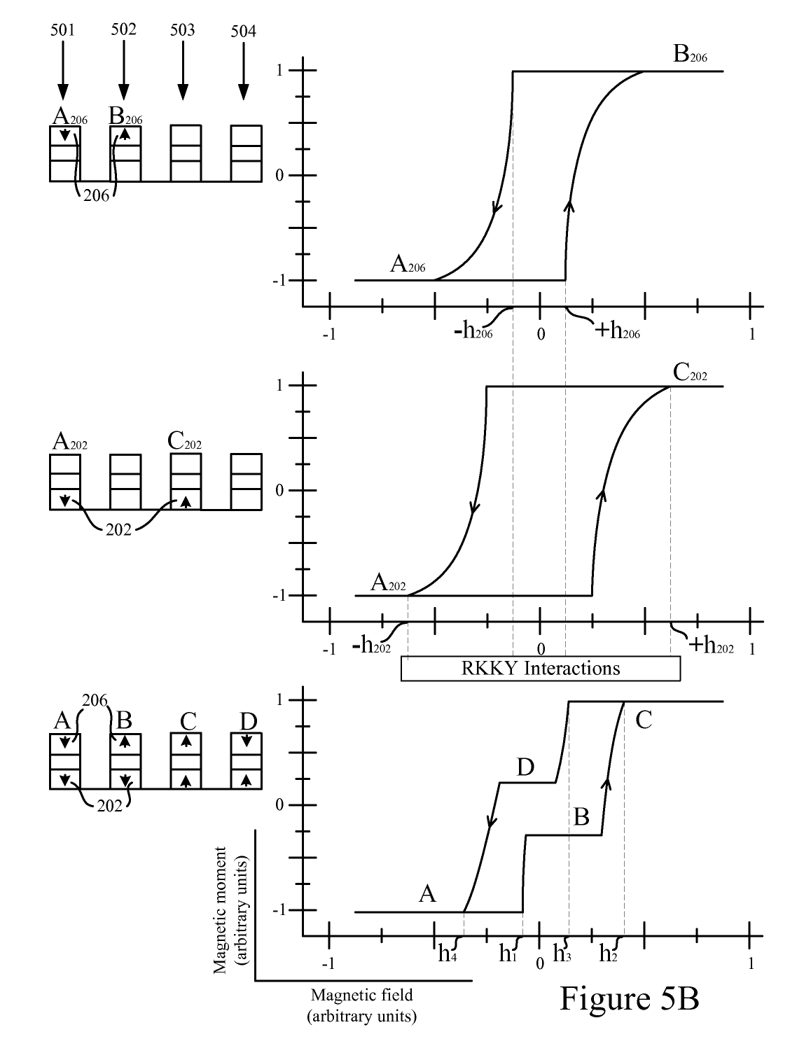

In one embodiment, the interaction between different magnetic layers is a balancing of magnetic forces. Generally, the most relevant magnetic forces affecting the inter-magnetic layer interactions are exchange-type interactions, magnetostatic-type interactions, and RKKY-type interactions. Generally, exchange interactions are the controlling forces affecting nearby dipoles. Exchange interactions cause the parallel alignment and interlayer coupling that is depicted and described with reference to FIGS. 3B and 3C. While magnetostatic forces are comparatively weaker than exchange interactions, magnetostatic interactions are comparatively longer-ranged and thus cause instability in the decoupled/uncoupled magnetic layers that are depicted and described with reference to FIGS. 4A and 4B. Finally, the RKKY interaction is, in one embodiment, an indirect exchange interaction that creates the anti-ferromagnetic coupling between magnetic layers that is depicted and described with reference to FIGS. 5A and 5B.

FIG. 3B is a cross-sectional side view of one embodiment of a magnetic recording medium that includes two magnetic layers 202, 206 that are magnetically coupled across an intermediate layer 204. Even in some applications where there is an intermediate layer 204 between the two magnetic layers 202, 206, if the intermediate layer 204 does not include the proper chemical composition and/or the intermediate layer 204 does not have the proper thickness when compared to the other magnetic layers, the two magnetic layers 202, 206 will behave as a single layer of magnetic material because the magnetic dipoles are strongly exchange coupled. Generally when the intermediate layer 204 is too thin, the magnetic layers 202, 206 are coupled and switch polarization together. However, in some embodiments, when the intermediate layer 204 is substantially too thick, the magnetic layers 202, 206 are no longer coupled and switch polarization independently. The determination of whether the intermediate layer 204 facilitates magnetic coupling is based upon the specifics of a given application. For example, factors that may affect whether the intermediate layer magnetically couples the magnetic layers together include: the type and composition of the magnetic layer materials, the type and composition of the intermediate layer(s) materials, the thickness of the intermediate layer(s), and the thickness of the magnetic layers, among others. A description of a specific embodiment, including specific details relating to these factors, is included below with reference to FIG. 5B.

FIG. 3C shows hysteresis loops for a magnetic recording medium that includes two magnetic layers 202, 206 that either have no intermediate layer between the magnetic layers or that are magnetically coupled across an intermediate layer 204. A hysteresis loop shows the non-linear response of magnetization (i.e. magnetic moment and magnetic polarization) caused by changes in an applied external magnetic field and also shows how magnetization response is dependent on the past magnetization state of the material. A hysteresis loop generally includes magnetic field units of measurement along the x-axis and magnetic moment units of measurement along the y-axis. However, for clarity and conceptual understanding, the units on the hysteresis loops included in the present disclosure are arbitrary and the values have been standardized to a maximum magnitude of either −1 or 1. Specific embodiments including actual units and values are included below with reference to FIG. 5B.

The top graph in FIG. 3C depicts one embodiment of a main hysteresis loop for a material constituting the second magnetic layer 206. This chart shows one embodiment of the magnetic polarization response of a second magnetic layer 206 as a function of applied external magnetic field. As the depicted embodiment shows, the second magnetic layer material 206, analyzed separately from the other layers, may be polarized to one of two magnetic states (A₂₀₆ and C₂₀₆). Starting at negative polarization state A₂₀₆, a positive external magnetic field may be applied over the second magnetic layer 206, causing the magnetic moment of the layer to switch to the positive polarization state C₂₀₆. Once the second magnetic layer 206 has switched to positive polarization state C₂₀₆, a negative external magnetic field may be applied over the second magnetic layer 206, causing the magnetic moment of the layer to switch back to negative polarization state A₂₀₆. Thus, a magnetic recording medium consisting of magnetic bits of only a single layer of the second magnetic layer material 206 would provide conventional binary data storage on each bit because each bit would be capable of switching between the two magnetic polarization states A₂₀₆ and C₂₀₆.

The middle graph in FIG. 3C depicts one embodiment of a main hysteresis loop for the material constituting the first magnetic layer 202. This chart shows one embodiment of the magnetic polarization response of a first magnetic layer 202 as a function of applied external magnetic field. As the depicted embodiment shows, the first magnetic layer material 202, analyzed separately from the other layers, may be polarized to one of two magnetic states (A₂₀₂ and C₂₀₂). Starting at negative polarization state A₂₀₂, a positive external magnetic field may be applied over the first magnetic layer 202, causing the magnetic moment of the layer to switch to positive polarization state C₂₀₂. Once the first magnetic layer 202 has switched to positive polarization state C₂₀₂, a negative external magnetic field may be applied over the first magnetic layer 202, causing the magnetic moment of the layer to switch back to negative polarization state A₂₀₂. Thus, a magnetic recording medium consisting of magnetic bits of only a single layer of the first magnetic layer material 202 would provide conventional binary data storage on each bit because each bit would be capable of switching between the two magnetic polarization states A₂₀₂ and C₂₀₂.

The bottom graph in FIG. 3C depicts one embodiment of a main hysteresis loop for the combination of both magnetic layers 202, 206 in a magnetic recording medium. As described above with reference to FIG. 3B, when the intermediate layer is not present or when the intermediate layer is of a certain thickness, the two magnetic layers are magnetically coupled and they switch together between a positive magnetic polarization state C and a negative magnetic polarization state A.

The dotted lines in FIG. 3C are not intended to show an exact correlation between the hysteresis loops of the individual layers and the hysteresis loop of the magnetic recording medium with the layers combined. Rather, the dotted lines generally show how, when the two magnetic layers 202, 206 are magnetically coupled in a single magnetic recording medium, the magnetic properties of the magnetic recording medium, as shown by the bottom hysteresis loop, are substantially an average of the magnetic properties of the individual magnetic layers. Thus, in terms of areal information density, a magnetic recording medium that has multiple magnetic layers that are magnetically coupled together does not create more magnetic states than a magnetic recording medium that has a single magnetic layer, according to one embodiment. While there may be advantages in terms of magnetic and thermal stability when using multiple coupled magnetic layers, an increase in areal information density is not a direct result of a plurality of magnetically coupled layers.

FIG. 4A is a cross-sectional side view of one embodiment of a magnetic recording medium that includes two magnetic layers 202, 206 that are magnetically decoupled across an intermediate layer 204. In the depicted embodiment, a first anisotropic magnetic layer 202 is on a substrate 104, an intermediate layer 204 is on the first anisotropic magnetic layer 202, and a second anisotropic magnetic layer 206 is on the intermediate layer 204. Four bits 401, 402, 403, 404 are also depicted and represent generally the four magnetic states (A, B, C, and D) of the dipoles of the decoupled magnetic layers 202, 206.

In one embodiment, the intermediate layer 204 may be thick enough to space apart the multiple magnetic layers 202, 206 so that instead of being magnetically coupled (as in the embodiments depicted in FIGS. 3A, 3B, and 3C) the magnetic layers are magnetically decoupled. For example, in one embodiment the magnetic layers 202, 206 switch between their respective magnetic polarization states independently.

FIG. 4B shows hysteresis loops for a magnetic recording medium that includes two magnetic layers 202, 206 that are magnetically decoupled by an intermediate layer 204. The difference between coupling intermediate layers (see FIGS. 3A, 3B, and 3C) and decoupling intermediate layers (see FIGS. 4A and 4B) is based upon the specifics of a given application. Although a decoupling intermediate layer is generally thicker than coupling intermediate layers, other factors may affect whether the intermediate layer 204 couples or decouples the magnetic layers. For example, factors may include: the type and composition of the magnetic layer materials, the type and composition of the intermediate layer materials, the thickness of the intermediate layer, and the thickness of the magnetic layers, among others. A description of specific embodiments, including specific details relating to these factors, is included below with reference to FIG. 5B.

The top graph in FIG. 4B depicts one embodiment of a main hysteresis loop for a material constituting the second magnetic layer 206. This chart shows one embodiment of the magnetic polarization response of a second magnetic layer 206 as a function of an applied external magnetic field. As the depicted embodiment shows, the second magnetic layer material 206, analyzed separately from the other layers, may be polarized to one of two magnetic states (A₂₀₆ and B₂₀₆). Starting at negative polarization state A₂₀₆, a positive external magnetic field with a magnitude of about +h₂₀₆ may be applied over the second magnetic layer 206, causing the magnetic moment of the layer to switch to positive polarization state B₂₀₆. Once the second magnetic layer 206 has switched to positive polarization state B₂₀₆, a negative external magnetic field with a magnitude of about −h₂₀₆ may be applied over the second magnetic layer 206, causing the magnetic moment of the layer to switch back to negative polarization state A₂₀₆. Thus, a magnetic recording medium consisting of magnetic bits of only a single layer of the second magnetic layer material 206 would provide conventional binary data storage on each bit because each bit would be capable of switching between the two magnetic polarization states A₂₀₆ and B₂₀₆.

The middle graph in FIG. 4B depicts one embodiment of a main hysteresis loop for the material constituting the first magnetic layer 202. This chart shows one embodiment of the magnetic polarization response of a first magnetic layer 202 as a function of applied external magnetic field. As the depicted embodiment shows, the first magnetic layer material 202, analyzed separately from the other layers, may be polarized to one of two magnetic states (A₂₀₂ and C₂₀₂). Starting at negative polarization state A₂₀₂, a positive external magnetic field with a magnitude of about +h₂₀₂ may be applied over the first magnetic layer 202, causing the magnetic moment of the layer to switch to positive polarization state C₂₀₂. Once the first magnetic layer 202 has switched to positive polarization state C₂₀₂, a negative external magnetic field with a magnitude of about −h₂₀₂ may be applied over the first magnetic layer 202, causing the magnetic moment of the layer to switch back to negative polarization state A₂₀₂. Thus, a magnetic recording medium consisting of magnetic bits of only a single layer of the first magnetic layer material 202 would provide conventional binary data storage on each bit because each bit would be capable of switching between the two magnetic polarization states A₂₀₂ and C₂₀₂.

The bottom graph in FIG. 4B depicts one embodiment of a main hysteresis loop for the combination of both magnetic layers 202, 206 in a magnetic recording medium. As the depicted embodiment shows and as described above with reference to FIG. 4A, in one embodiment when the intermediate layer 204 is comparatively thicker than the coupling intermediate layer depicted in FIG. 3B, the magnetic layers 202, 206 are substantially decoupled (uncoupled) and the magnetic dipoles of the two magnetic layers 202, 206 may independently switch between magnetic polarization states. In other words, one magnetic layer in a magnetic bit may switch polarization states while the other layer in the same magnetic bit does not switch polarization states. Thus, as seen in the second bit 402 and the fourth bit 404, the dipoles in the two magnetic layers may have opposite magnetic moments (opposite polarization states).

Starting at polarization state A, where both magnetic layers have negative dipoles, a positive external magnetic field with a magnitude of about +h₂₀₆ may be applied over the magnetic recording medium, causing the magnetic moment of the second anisotropic magnetic layer 206 to switch to positive polarization state B₂₀₆ and the overall magnetic moment of the magnetic recording medium to switch to polarization state B. Once at state B, a positive external magnetic field with a magnitude of about h₂₀₂ may be applied over the magnetic recording medium, causing the magnetic moment of the first anisotropic magnetic layer 202 to switch to positive polarization state C₂₀₂ and overall magnetic moment of the magnetic recording medium to switch to polarization state C.

Once at polarization state C, where both magnetic layers have positive dipoles, a negative external magnetic field with a magnitude of about −h₂₀₆ may be applied over the magnetic recording medium, causing the magnetic moment of the second anisotropic magnetic layer 206 to switch to negative polarization state A₂₀₆ and the overall magnetic moment of the magnetic recording medium to switch to polarization state D. Once at state D, a negative external magnetic field with a magnitude at or just above −h₂₀₂ may be applied over the magnetic recording medium, causing the magnetic moment of the first anisotropic magnetic layer 202 to switch to negative polarization state A₂₀₂ and overall magnetic moment of the magnetic recording medium to switch back to polarization state A.

The dotted lines in FIG. 4B are not intended to show an exact correlation between the hysteresis loops of the individual layers and the hysteresis loop of the combined, albeit decoupled, layers. Rather, the dotted lines generally show how, when the two magnetic layers 202, 206 are magnetically decoupled, the magnetic recording medium includes four magnetization states (A, B, C, and D) and therefore, in one embodiment, may record and store twice the information per bit when compared to conventional bits with only two magnetic states.

In one embodiment, however, while the decoupling of the magnetic layers creates more magnetic states, the magnetic states may not be stable. Magnetostatic forces are generally weaker than the coupling exchange interactions (see description of FIG. 3A) but the effects of magnetostatic forces are felt at a comparatively longer-range. Thus, the dipoles in separate magnetic layers that are spaced apart with comparatively thick intermediate layers are less affected by the exchange interaction and more affected by the long-range magnetostatic interactions. In one embodiment, the magnetostatic interactions may cause spontaneous magnetic polarity reversals. Therefore, while decoupling magnetic layers creates more magnetic states per bit, the magnetic states may not be stable.

FIG. 5A is a cross-sectional side view of one embodiment of a magnetic recording medium that includes two magnetic layers 202, 206 that are anti-ferromagnetically coupled across an intermediate layer 204. In the depicted embodiment, a first anisotropic magnetic layer 202 is on a substrate 104, an intermediate layer 204 is on the first anisotropic magnetic layer 202, and a second anisotropic magnetic layer 206 is on the intermediate layer 204. Four bits 501, 502, 503, 504 are also depicted and represent generally the four magnetic configurations of the dipoles of the anti-ferromagnetically coupled magnetic layers 202, 206.

The anti-ferromagnetic coupling intermediate layer is different than the coupling intermediate layers (see FIGS. 3A, 3B, and 3C) and decoupling intermediate layers (see FIGS. 4A and 4B). In one embodiment, the anti-ferromagnetic coupling layer 204 may have a specific thickness to space apart the multiple magnetic layers 202, 206 so that instead of being magnetically coupled (as in the embodiments depicted in FIGS. 3A, 3B, and 3C) or magnetically decoupled (as in the embodiments depicted in FIGS. 4A and 4B) the magnetic layers are anti-ferromagnetically coupled.

In one embodiment, the thickness ratio of the first anisotropic magnetic layer 206 and the anti-ferromagnetic intermediate layer 204 is relevant to a stable anti-ferromagnetically coupled magnetic recording medium. In one embodiment the ratio of the thickness 512 of the first magnetic layer 202 to the thickness 514 of the anti-ferromagnetic intermediate layer 204 is in the range of between about 2:1 to 10:1. In another embodiment the ratio of the thickness 512 of the first magnetic layer 202 to the thickness 504 of the anti-ferromagnetic intermediate layer 514 is in the range of between about 5:1 to 7:1. In yet another embodiment the ratio of the thickness 602 of the first magnetic layer 512 to the thickness 514 of the anti-ferromagnetic intermediate layer 206 is about 6:1.

In one embodiment, the thickness ratio of the first anisotropic magnetic layer 206 and the second anisotropic magnetic layer 202 is relevant to a stable anti-ferromagnetically coupled magnetic recording medium. In one embodiment the ratio of the thickness 512 of the first magnetic layer 202 to the thickness 516 of the second magnetic layer 506 is in the range of between about 3:2 to 10:1. In another embodiment the ratio of the thickness 512 of the first magnetic layer 202 to the thickness 516 of the second magnetic layer 206 is in the range of between about 5:2 to 8:1. In yet another embodiment the ratio of the thickness 512 of the first magnetic layer 202 to the thickness 516 of the second magnetic layer 206 is about 4:1.

Although the anti-ferromagnetic intermediate layer is generally thicker than coupling intermediate layers and thinner than decoupling intermediate layers, other factors may affect the anti-ferromagnetic nature of the intermediate layer. For example, factors may include: the type and composition of the magnetic layer materials, the type and composition of the intermediate layer materials, the thickness of the intermediate layer, and the thickness of the magnetic layers, among others. A description of specific embodiments, including specific details relating to these factors, is included below with reference to FIG. 5B.

FIG. 5B shows hysteresis loops for a magnetic recording medium that includes two magnetic layers 202, 206 that are anti-ferromagnetically coupled across an intermediate layer 204. This anti-ferromagnetic coupling, in one embodiment, allows each magnetic layer 202, 206 on each bit to switch between magnetic polarization states pseudo-independently of the other magnetic layers while still maintaining a stable RKKY coupling with the other magnetic layers. RKKY coupling interactions between magnetic layers 202, 206 is discussed in greater detail below.

The top graph in FIG. 5B depicts one embodiment of a main hysteresis loop for a material constituting the second magnetic layer 206. This chart shows one embodiment of the magnetic polarization response of a second magnetic layer 206 as a function of an applied external magnetic field. As the depicted embodiment shows, the second magnetic layer material 206, analyzed separately from the other layers, may be polarized to one of two magnetic states (A₂₀₆ and B₂₀₆). Starting at negative polarization state A₂₀₆, a positive external magnetic field with a magnitude of or just greater than +h₂₀₆ may be applied over the second magnetic layer 206, causing the magnetic moment of the layer to switch to positive polarization state B₂₀₆. Once the second magnetic layer 206 has switched to positive polarization state B₂₀₆, a negative external magnetic field with a magnitude of or just greater than −h₂₀₆ may be applied over the second magnetic layer 206, causing the magnetic moment of the layer to switch back to negative polarization state A₂₀₆. Thus, a magnetic recording medium consisting of magnetic bits of a single layer of the second magnetic layer material 206 would provide binary data storage on each bit because each bit would be capable of switching between the two magnetic polarization states A₂₀₆ and B₂₀₆.

The middle graph in FIG. 5B depicts one embodiment of a main hysteresis loop for the material constituting the first magnetic layer 202. This chart shows one embodiment of the magnetic polarization response of a first magnetic layer 202 as a function of applied external magnetic field. As the depicted embodiment shows, the first magnetic layer material 202, analyzed separately from the other layers, may be polarized to one of two magnetic states (A₂₀₂ and C₂₀₂). Starting at negative polarization state A₂₀₂, a positive external magnetic field with a magnitude of or just greater than +h₂₀₂ may be applied over the first magnetic layer 202, causing the magnetic moment of the layer to switch to positive polarization state C₂₀₂. Once the first magnetic layer 202 has switched to positive polarization state C₂₀₂, a negative external magnetic field with a magnitude of or just greater than −h₂₀₂ may be applied over the first magnetic layer 202, causing the magnetic moment of the layer to switch back to negative polarization state A₂₀₂. Thus, a magnetic recording medium consisting of magnetic bits of a single layer of the first magnetic layer material 202 would provide binary data storage on each bit because each bit would be capable of switching between the two magnetic polarization states (A₂₀₂ and C₂₀₂).

The bottom graph in FIG. 5B depicts one embodiment of a main hysteresis loop for the combination of both magnetic layers 202, 206 in a magnetic recording medium. As the depicted embodiment shows and as described above with reference to FIG. 5A, in one embodiment, when the intermediate layer 204 is comparatively thicker than a coupling intermediate layer depicted in FIG. 3B and comparatively thinner than a decoupling intermediate layer depicted in FIG. 4A, the magnetic layers 202, 206 are substantially anti-ferromagnetically coupled and the magnetic dipoles of the two magnetic layers 202, 206 may pseudo-independently switch between magnetic polarization states. In other words, one magnetic layer in a magnetic bit may switch polarization states while the other layer in the same magnetic bit does not switch polarization states. Thus, as seen in the second bit 502 and the fourth bit 504, the dipoles in the two magnetic layers may have opposite magnetic moments (opposite polarization states).

Starting at polarization state A, where both magnetic layers have negative dipoles, an external magnetic field with a magnitude of about h₁ may be applied over the magnetic recording medium, causing the magnetic moment of the second anisotropic magnetic layer 206 to switch to a positive polarization state and the overall magnetic moment of the magnetic recording medium to switch to polarization state B. Once at state B, an external magnetic field with a magnitude of about h₂ may be applied over the magnetic recording medium, causing the magnetic moment of the first anisotropic magnetic layer 202 to switch to a positive polarization state and the overall magnetic moment of the magnetic recording medium to switch to positive polarization state C.

Once at polarization state C, where both magnetic layers have positive dipoles, an external magnetic field with a magnitude of about h₃ may be applied over the magnetic recording medium, causing the magnetic moment of the second anisotropic magnetic layer 206 to switch to a negative polarization state and the overall magnetic moment of the magnetic recording medium to switch to polarization state D. Once at state D, an external magnetic field with a magnitude of about h₄ may be applied over the magnetic recording medium, causing the magnetic moment of the first anisotropic magnetic layer 202 to switch to a negative polarization state and the overall magnetic moment of the magnetic recording medium to switch back to negative polarization state A.

The dotted lines in FIG. 5B are not intended to show an exact correlation or relationship between the hysteresis loops of the individual layers and the hysteresis loop of the combined layers. Rather, the dotted lines generally show how, when the two magnetic layers 202, 206 are anti-ferromagnetically coupled, the apparent switching fields and apparent coercivity of the magnetic recording medium is altered due to the RKKY interactions. The magnetic recording medium of FIG. 5A/5B includes four magnetization states (A, B, C, and D) and therefore, in one embodiment, may record and stably store at least twice the information per bit when compared to conventional bits with only two magnetic states.

RKKY interactions involve indirect exchange interactions. As described above, exchange interactions are generally responsible for coupling magnetic layers so that the dipoles in each layer have the same alignment and polarization state. These exchange interactions occur as valence electrons from the magnetic layers interact with each other. It is anticipated that, when magnetic layers of certain compositions and thicknesses are spaced apart by a non-magnetic layer of a certain composition and thickness, an indirect exchange interaction occurs where one of the “conducting” electrons of the magnetic layers functions as an interaction point about which each magnetic layer interacts. In other words, instead of the electrons of the magnetic layers interacting directly with each other across a coupling layer, a conducting electron(s) essentially positions itself in the anti-ferromagnetic intermediate layer between the magnetic layers and functions as an intermediary interaction point. Thus, these RKKY interactions enable anti-ferromagnetic coupling between the magnetic layers.

In such anti-ferromagnetically coupled magnetic layers, there are no magnetostatic interactions and therefore the stability of the polarization states, wherein the constituent magnetic layers have opposing magnetizations, is greatly stabilized. Furthermore, the signal amplitude (information content) arising from said anti-ferromagnetically coupled states is readily tuned by judicious selection of the magnetic moment and thickness of the constituent magnetic layers. Thereby readily permitting not only the signal amplitude corresponding to the magnetic states but also to the applied field required to access or write said anti-ferromagnetically coupled states.

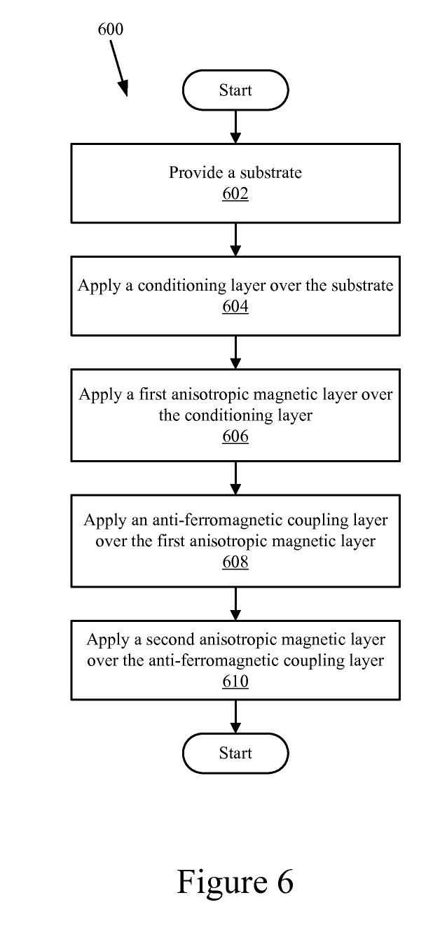

FIG. 6 is a schematic flow chart diagram of one embodiment of a method 600 for fabricating a multi-layer magnetic recording medium. The method includes providing 602 a substrate. The substrate, as described above with reference to FIG. 1B, may include a silicon wafer or other similar material, such as glass, aluminum alloy, nickel alloy, silicon alloy, and the like. The substrate, in one embodiment, may already have bit-patterned features. In another embodiment the substrate may be substantially smooth.

The method also includes applying 604 a conditioning layer over the substrate. The conditioning layer, as described above with reference to FIG. 1B, may be applied through sputtering, chemical vapor deposition (“CVD”), thermal evaporation, or electrochemical techniques or atomic layer deposition (“ALD”) techniques, among others. The conditioning layer 105 may also include various masking materials that protect the substrate. For example, the conditioning layer may include masking materials that facilitate fabrication of a bit-patterned substrate. In another embodiment, the conditioning layer may include materials that promote the formation of the desired crystalline structure of the magnetic alloy to achieve strong out-of-plane magnetic anisotropy.

The method further includes applying 606 a first anisotropic magnetic layer over the conditioning layer. The composition and thickness of the first anisotropic magnetic layer, according to one embodiment, are important for achieving the desired anti-ferromagnetic coupling. The method also includes applying 608 an anti-ferromagnetic coupling layer over the first magnetic layer. The composition and thickness of the anti-ferromagnetic coupling layer, according to one embodiment, are important for achieving anti-ferromagnetic coupling.

The method finally includes applying 610 a second anisotropic magnetic layer over the anti-ferromagnetic coupling layer. Once again, the composition and thickness of the first anisotropic magnetic layer, according to one embodiment, are important for achieving the desired anti-ferromagnetic coupling. The multiple magnetic layers, as described above with reference to FIG. 2B, may experience RKKY interactions across the anti-ferromagnetic coupling layer. These interactions stabilize the polarities of the individual anisotropic magnetic layers, enabling a magnetic recording medium to have more than the conventional two magnetic states.

The following examples are specific implementations of magnetic recording mediums according to the subject matter and methods generally disclosed herein. All of the following examples include substantially the same substrate 104 and conditioning layer 105. A glass substrate 104 that was coated with a conditioning layer 105. The conditioning layer included a 20 nanometer (“nm”) nickel-tantalum layer on the glass, a 5 nm nickel-tungsten layer coating the nickel-tantalum layer, an 18 nm ruthenium layer coating the nickel-tungsten layer, and a 0.25 nm tantalum-oxide nucleation layer coating the ruthenium layer.

### Example 1

### Coupled Magnetic Recording Medium

The magnetic recording medium included a first magnetic layer 202 applied over the conditioning layer 105 as described above, wherein the first magnetic layer 202 was an 8 nmCoCr₇Pt₂₅ layer. On top of the first magnetic layer 202 was a 1 nm ruthenium-cobalt intermediate layer 204. On top of the intermediate layer 204 was a 3 nm second magnetic layer that comprised CoCr₁₈Pt₁₂. The magnetic layers were magnetically coupled and a hysteresis analysis only showed two magnetic states.

### Example 2

### Decoupled Magnetic Recording Medium

The magnetic recording medium included a first magnetic layer 202 applied over the conditioning layer 105 as described above, wherein the first magnetic layer 202 was an 8 nmCoCr₇Pt₂₅ layer. On top of the first magnetic layer 202 was a 4 nm ruthenium-cobalt intermediate layer 204. On top of the intermediate layer 204 was a 3 nm second magnetic layer that comprised CoCr₁₈Pt₁₂. The magnetic layers were magnetically decoupled and the hysteresis analysis showed four magnetic states. The four magnetic states, however, were unstable due to magnetostatic interactions.

### Example 3

### Anti-Ferromagnetic Recording Medium

The magnetic recording medium included a first magnetic layer 202 applied over the conditioning layer 105 as described above, wherein the first magnetic layer 202 was an 8 nmCoCr₇Pt₂₅ layer. On top of the first magnetic layer 202 was a 1.5 nm ruthenium-cobalt intermediate layer 204. On top of the intermediate layer 204 was a 3 nm second magnetic layer that comprised CoCr₁₈Pt₁₂. The magnetic layers were anti-ferromagnetically coupled and the hysteresis loop showed four stable magnetic states.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment.

Furthermore, the described features, structures, or characteristics of the disclosure may be combined in any suitable manner in one or more embodiments. In the following description, numerous specific details are provided. One skilled in the relevant art will recognize, however, that the subject matter of the present application may be practiced without one or more of the specific details, or with other methods, components, materials, and so forth. In other instances, well-known structures, materials, or operations are not shown or described in detail to avoid obscuring aspects of the disclosure.

The subject matter of the present disclosure may be embodied in other specific forms without departing from its spirit or essential characteristics. The described embodiments are to be considered in all respects only as illustrative and not restrictive. The scope of the disclosure is, therefore, indicated by the appended claims rather than by the foregoing description. All changes which come within the meaning and range of equivalency of the claims are to be embraced within their scope.

What is claimed is:

1. A magnetic recording medium comprising:
a substrate;
a plurality of anisotropic magnetic layers applied over the substrate; and
at least one anti-ferromagnetic coupling layer between two adjacent anisotropic magnetic layers of the plurality of anisotropic magnetic layers.

2. The magnetic recording medium of claim 1, wherein each of the plurality of anisotropic magnetic layers is spaced apart from another of the anisotropic magnetic layers by an anti-ferromagnetic coupling layer.

3. The magnetic recording medium of claim 2, wherein a ratio of the thickness of an anisotropic magnetic layer directly coating the substrate to an adjacent anti-ferromagnetic coupling layer is in the range of between about 2:1 and 10:1.

4. The magnetic recording medium of claim 2, wherein each bit of the magnetic recording medium is capable of achieving a number of magnetic states equal to at least 2ⁿ, wherein the plurality of anisotropic magnetic layers comprises an n number of layers.

5. The magnetic recording medium of claim 1, wherein the substrate comprises bit-patterned features.

6. The magnetic recording medium of claim 1, wherein the anisotropic magnetic layers and the anti-ferromagnetic coupling layer comprise bit-patterned features.

7. The magnetic recording medium of claim 6, wherein the substrate further comprises a conditioning layer.

8. The magnetic recording medium of claim 1, wherein the conditioning layer comprises an oxide-nucleation layer.

9. The magnetic recording medium of claim 1, wherein at least one of the anisotropic magnetic layers comprises a cobalt-platinum-chromium alloy.

10. The magnetic recording medium of claim 1, wherein the anti-ferromagnetic coupling layer comprises a ruthenium-cobalt alloy.

11. The magnetic recording medium of claim 1, wherein the at least one anti-ferromagnetic coupling layer comprises a first anti-ferromagnetic coupling layer and a second anti-ferromagnetic coupling layer, and wherein the two anisotropic magnetic layers comprise a first anisotropic magnetic layer and a second anisotropic magnetic layer, the plurality of anisotropic magnetic layers further comprising a third anisotropic magnetic layer, the second anisotropic magnetic layer being between the first and third anisotropic magnetic layers, wherein the first anti-ferromagnetic coupling layer is positioned between the first and second anisotropic magnetic layers and the second anti-ferromagnetic coupling layer is positioned between the second and third anisotropic magnetic layers.

12. A bit-patterned magnetic recording medium comprising:
a substrate;
a conditioning layer;
a first anisotropic magnetic layer applied over the conditioning layer;
an anti-ferromagnetic coupling layer applied over the first anisotropic magnetic layer; and
a second anisotropic magnetic layer applied over the anti-ferromagnetic coupling layer.

13. The bit-patterned magnetic recording medium of claim 12, wherein the conditioning layer comprises an oxide-nucleation layer.

14. The bit-patterned magnetic recording medium of claim 12, wherein the first anisotropic magnetic layer comprises a first cobalt-platinum-chromium alloy and the second anisotropic magnetic layer comprises a second cobalt-platinum-chromium alloy.

15. The bit-patterned magnetic recording medium of claim 14, wherein the first cobalt-platinum-chromium alloy is CoCr₇Pt₂₅ and the second cobalt-platinum-chromium alloy is CoCr₁₈Pt₁₂.

16. The bit-patterned magnetic recording medium of claim 12, wherein the anti-ferromagnetic coupling layer comprises a ruthenium-cobalt alloy.

17. The bit-patterned magnetic recording medium of claim 12, wherein the thickness ratio of the first anisotropic magnetic layer to the anti-ferromagnetic coupling layer is between about 2:1 and 10:1.

18. The bit-patterned magnetic recording medium of claim 12, wherein the thickness ratio of the first anisotropic magnetic layer to the anti-ferromagnetic coupling layer is between about 5:1 and 7:1.

19. The bit-patterned magnetic recording medium of claim 12, wherein the thickness ratio of the first anisotropic magnetic layer to the anti-ferromagnetic coupling layer is about 6:1.

20. The bit-patterned magnetic recording medium of claim 12, wherein the thickness ratio of the first anisotropic magnetic layer to the second anisotropic magnetic layer is between about 3:2 and 10:1.

21. The bit-patterned magnetic recording medium of claim 12, wherein the thickness ratio of the first anisotropic magnetic layer to the second anisotropic magnetic layer is between about 5:2 and 8:1.

22. The bit-patterned magnetic recording medium of claim 12, wherein the thickness ratio of the first anisotropic magnetic layer to the second anisotropic magnetic layer is about 4:1.

23. The bit-patterned magnetic recording medium of claim 12, wherein the substrate comprises self-assembled block copolymer patterns.

24. The bit-patterned magnetic recording medium of claim 12, wherein the bit-patterned magnetic recording medium is a hard disk of a magnetic recording device.

25. A method for fabricating an anti-ferromagnetic recording medium comprising:
providing a substrate;
applying a conditioning layer over the substrate;
applying a first anisotropic magnetic layer over the conditioning layer;
applying an anti-ferromagnetic coupling layer over the first anisotropic magnetic layer; and
applying a second anisotropic magnetic layer over the anti-ferromagnetic coupling layer.
